(19) United States
(12) Patent Application Publication
(10) Pub. No.: US 2013/0211885 A1
(43) Pub. Date: Aug. 15, 2013

(54) Electricity Transfer System and Method of Providing and Using the Same

(71) Applicant: Carmelo A. Carpinteri, Phoenix, AZ (US)

(72) Inventor: Carmelo A. Carpinteri, Phoenix, AZ (US)

(73) Assignee: Electric Transportation Engineering Corporation d/b/a ECOtality North America, Phoenix, AZ (US)

(21) Appl. No.: 13/371,011

(22) Filed: Feb. 10, 2012

(51) Int. Cl. H02J 7/00; G06Q 30/02

(52) U.S. Cl. 705/14.1; 320/109; 320/137

(57) ABSTRACT

Some embodiments include an electricity transfer system. Other embodiments of related systems and methods are also disclosed.

### STATEMENT REGARDING FEDERALLY SPONSORED RESEARCH OR DEVELOPMENT

This invention was made with U.S. Government support under Contract No. DE-EE00002194 awarded by the Department of Energy. The Government has certain rights in this invention.

### FIELD OF THE INVENTION

This invention relates generally to an electricity transfer system, and relates more particularly to an electricity transfer system for administrating one or more multi-use electric vehicle charging stations and methods of providing and using the same.

### DESCRIPTION OF THE BACKGROUND

Because many electric vehicle charging stations are owned and/or leased by private hosts, these electric vehicle charging stations are often unavailable for use by others without the approval of those private hosts. Accordingly, a need or potential for benefit exists for an electricity transfer system for making privately-owned or privately-leased electric vehicle charging stations available for use by others, in order to increase the quality and geographic distribution of electric vehicle charging stations available for public use.

### BRIEF DESCRIPTION OF THE DRAWINGS

To facilitate further description of the embodiments, the following drawings are provided in which:

FIG. 1 illustrates a representative block diagram of an electricity transfer system, according to an embodiment;

FIG. 2 illustrates a flow chart for an embodiment of a method of providing an electricity transfer system;

FIG. 3 illustrates a flow chart for an embodiment of a method of operating an electricity transfer system network computer system and/or an application programmable interface;

FIG. 4 illustrates an exemplary process of offering and/or providing one or more incentives to one or more private hosts of one or more multi-use EVCS's when the multi-use EVCS('s) are operating in a public mode, according to the embodiment of FIG. 3;

FIG. 5 illustrates a representative block diagram of an electricity transfer system, according to an embodiment;

FIG. 6 illustrates a computer system that is suitable for implementing an embodiment of an electric transfer system network computer system, a multi-use electric vehicle charging station computer system, a public electric vehicle charging station computer system, and/or a private electric vehicle charging station computer system; and

FIG. 7 illustrates a representative block diagram of exemplary components and/or circuitry included in exemplary circuit boards inside a chassis of the computer system of FIG. 6.

For simplicity and clarity of illustration, the drawing figures illustrate the general manner of construction, and descriptions and details of well-known features and techniques may be omitted to avoid unnecessarily obscuring the invention. Additionally, elements in the drawing figures are not necessarily drawn to scale. For example, the dimensions of some of the elements in the figures may be exaggerated relative to other elements to help improve understanding of embodiments of the present invention. The same reference numerals in different figures denote the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements, but may include other elements not expressly listed or inherent to such process, method, system, article, device, or apparatus.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the invention described herein are, for example, capable of operation in other orientations than those illustrated or otherwise described herein.

The terms “couple,” “coupled,” “couples,” “coupling,” and the like should be broadly understood and refer to connecting two or more elements or signals, electrically, mechanically and/or otherwise. Two or more electrical elements may be electrically coupled together, but not be mechanically or otherwise coupled together; two or more mechanical elements may be mechanically coupled together, but not be electrically or otherwise coupled together; two or more electrical elements may be mechanically coupled together, but not be electrically or otherwise coupled together. Coupling may be for any length of time, e.g., permanent or semi-permanent or only for an instant.

“Electrical coupling” and the like should be broadly understood and include coupling involving any electrical signal, whether a power signal, a data signal, and/or other types or combinations of electrical signals. “Mechanical coupling” and the like should be broadly understood and include mechanical coupling of all types.

The absence of the word “removably,” “removable,” and the like near the word “coupled,” and the like does not mean that the coupling, etc. in question is or is not removable.

The term “real time” is defined with respect to operations carried out as soon as practically possible upon occurrence of a triggering event. A triggering event can comprise receipt of data necessary to execute a task or to otherwise process information. Because of delays inherent in transmission and/or in computing speeds, the term “real time” encompasses operations that occur in “near” real time or somewhat delayed from a triggering event.

### DETAILED DESCRIPTION OF EXAMPLES OF EMBODIMENTS

Some embodiments include an electricity transfer system. The electricity transfer system comprises an electricity transfer system network computer system and/or an application programmable interface. The electricity transfer system network computer system and/or the application programmable interface are configured to communicate with electric vehicle charging stations. The electric vehicle charging stations can be affiliated with an electricity transfer system network, and the electric transfer system network computer system and/or the application programmable interface can be configured to administrate the electricity transfer system network. The electricity transfer system network computer system and/or the application programmable interface can be operated by an electricity transfer system network operator, and the electric vehicle charging stations can comprise a multi-use electric vehicle charging station of a private host. Meanwhile, the multi-use electric vehicle charging station is configured to operate in a private mode and a public mode. When the multi-use electric vehicle charging station operates in the private mode, the private host can establish who is able to use the multi-use electric vehicle charging station, and when the multi-use electric vehicle charging station operates in the public mode, the electricity transfer system network operator can establish who is able to use the multi-use electric vehicle charging station. The electricity transfer system network operator can offer one or more incentives to the private host when the multi-use electric vehicle charging station operates in the public mode.

Various embodiments include a method of providing an electricity transfer system. The method can comprise: providing an electricity transfer system network computer system and/or an application programmable interface; and configuring the electricity transfer system network computer system and/or the application programmable interface to communicate with electric vehicle charging stations, where the electric vehicle charging stations are affiliated with an electricity transfer system network, and where the electric transfer system network computer system and/or the application programmable interface are configured to administrate the electricity transfer system network. The electricity transfer system network computer system and/or the application programmable interface are operated by an electricity transfer system network operator, and the electric vehicle charging stations comprise a multi-use electric vehicle charging station of a private host. Meanwhile, the multi-use electric vehicle charging station is configured to operate in a private mode and a public mode. When the multi-use electric vehicle charging station operates in the private mode, the private host can establish who is able to use the multi-use electric vehicle charging station, and when the multi-use electric vehicle charging station operates in the public mode, the electricity transfer system network operator can establish who is able to use the multi-use electric vehicle charging station. The electricity transfer system network operator can offer one or more incentives to the private host when the multi-use electric vehicle charging station operates in the public mode.

Further embodiments include a method of operating an electricity transfer system network computer system and/or an application programmable interface. At least part of the method can be implemented via execution of computer instructions configured to run at one or more processing modules and configured to be stored at one or more memory storage modules of the electricity transfer system network computer system and/or one or more cloud computer systems. The method can comprise: executing one or more first computer instructions configured to communicate with a multi-use electric vehicle charging station of electric vehicle charging stations, where the multi-use electric vehicle charging station is owned or leased by a private host and the multi-use electric vehicle charging station is configured to operate in a private mode and a public mode; executing one or more second computer instructions configured to establish who is able to use the multi-use electric vehicle charging station when the multi-use electric vehicle charging station operates in the public mode; and executing one or more third computer instructions configured to offer one or more incentives to the private host when the multi-use electric vehicle charging station operates in the public mode. The computer instructions can comprise the first, second, and third computer instructions.

Other embodiments include an electricity transfer system. The electricity transfer system comprises a multi-use electric vehicle charging station of a private host. The multi-use electric vehicle charging station is configured to communicate with an electricity transfer system network computer system and/or an application programmable interface. The multi-use electric vehicle charging station is also configured to operate in a private mode and a public mode. The electricity transfer system network computer system and/or the application programmable interface are configured to communicate with electric vehicle charging stations. Meanwhile, the electric vehicle charging stations are affiliated with an electricity transfer system network, and the electric transfer system network computer system and/or the application programmable interface are configured to administrate the electricity transfer system network. Furthermore, the electricity transfer system network computer system and/or the application programmable interface are operated by an electricity transfer system network operator. The electric vehicle charging stations comprise the multi-use electric vehicle charging station. When the multi-use electric vehicle charging station operates in the private mode, the private host can establish who is able to use the multi-use electric vehicle charging station, and when the multi-use electric vehicle charging station operates in the public mode, the electricity transfer system network operator can establish who is able to use the multi-use electric vehicle charging station. The electricity transfer system network operator can offer one or more incentives to the private host when the multi-use electric vehicle charging station operates in the public mode.

Still further embodiments include an electricity transfer system. The electricity transfer system comprises a multi-use electric vehicle charging station of a private host. The multi-use electric vehicle charging station can be configured to operate in a private mode and a public mode. When the multi-use electric vehicle charging station operates in the private mode, the private host can establish who is able to use the multi-use electric vehicle charging station, and when the multi-use electric vehicle charging station operates in the public mode, an electricity transfer system network operator can establish who is able to use the multi-use electric vehicle charging station. The electricity transfer system network operator can offer one or more incentives to the private host when the multi-use electric vehicle charging station operates in the public mode.

These electricity transfer systems and related methods can increase the number and geographic spread of publicly accessible electric vehicle charging stations and can also incentivize private hosts to make their electric vehicle charging stations available for use by others.

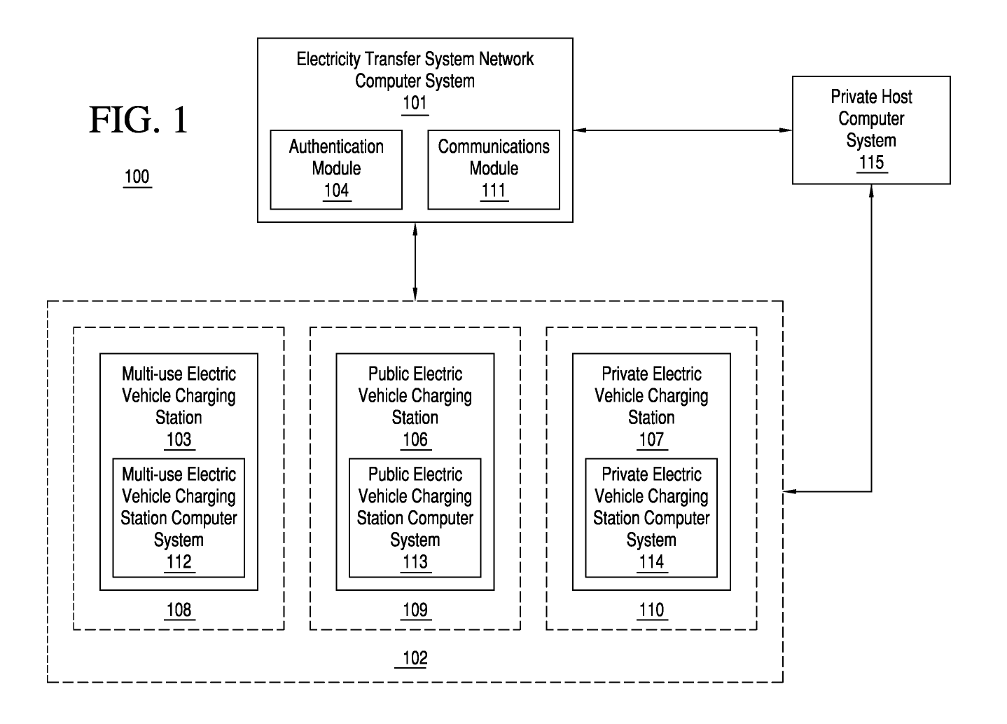

Turning to the drawings, FIG. 1 illustrates a representative block diagram of an electricity transfer system (ETS) 100, according to an embodiment. ETS 100 is merely exemplary and is not limited to the embodiments presented herein. ETS 100 can be employed in many different embodiments or examples not specifically depicted or described herein.

ETS 100 comprises electric vehicle charging stations (EVCS(s)) 102. ETS 100 can comprise electricity transfer system network (ETSN) computer system 101 and/or an electricity transfer system network (ETSN) application programmable interface (as described below). In further embodiments, the ETSN application programmable interface can be separate from ETS 100. ETS 100, ETSN computer system 101, and/or EVCS('s) 102 can comprise authentication module 104 and/or communication module 111. In some embodiments, ETSN computer system 102 can comprise the ETSN application programmable interface while in other embodiments, the ETSN application programmable interface can be separate from ETSN computer system 102. In some embodiments, ETS 100 can comprise one or more EVCS('s) 102. Meanwhile, ETS 100 and/or EVCS('s) 102 can comprise (a) one or more multi-use electric vehicle charging stations (EVCS's) 108 (e.g., multi-use EVCS 103), (b) one or more public electric vehicle charging stations (EVCS's) 109 (e.g., public EVCS 106), and/or (c) one or more private electric vehicle charging station (EVCS's) 110 (e.g., private EVCS 107). (Multi-use EVCS('s) 108, public EVCS('s) 109, and/or private EVCS('s) 110 can be distinguished from one another primarily in terms of accessibility and secondarily in terms of hardware implementation, as described below.) In other embodiments, one or more of EVCS('s) 102 (e.g., one or more of multi-use EVCS('s) 108 (e.g., multi-use EVCS 103), one or more of public EVCS('s) 109 (e.g., public EVCS 106), and/or one or more of private EVCS('s) 110 (e.g., private EVCS 107) can be separate from ETS 100. For example, in some embodiments, EVCS('s) 102 can comprise only multi-use EVCS('s) 108 (and/or public EVCS('s) 109) such that private EVCS('s) 110 (and/or public EVCS('s) 109) are omitted.

Meanwhile, each of multi-use EVCS('s) 108 (e.g., multi-use EVCS 103) can comprise one multi-use electric vehicle charging station (EVCS) computer system 112; each of public EVCS('s) 109 (e.g., public EVCS 106) can comprise one public electric vehicle charging station (EVCS) computer system 113; and/or each of private EVCS('s) 110 (e.g., private EVCS 107) can comprise one private electric vehicle charging station (EVCS) computer system 114.

Each electric vehicle charging station of EVCS('s) 102 can comprise electric vehicle supply equipment configured to transfer electricity to and/or from a rechargeable energy storage system of an electric vehicle. The electric vehicle supply equipment can be any suitable alternating current and/or direct current electric vehicle supply equipment. For example, each electric vehicle charging station of EVCS('s) 102 can comprise electric vehicle supply equipment configured according to any one of the Society of Automotive Engineers (SAE) International electric vehicle supply equipment standards (e.g., Level 1, Level 2, and/or Level 3) and/or the International Electrotechnical Commission (IEC) standards (e.g., Mode 1, Mode 2, Mode 3, and/or Mode 4).

The rechargeable energy storage system of the electric vehicle can be configured to provide electricity to the electric vehicle to provide motive (e.g., traction) electrical power to that electric vehicle and/or to provide electricity to any electrically operated components of that electric vehicle. The rechargeable energy storage system can be configured with and/or can comprise an electricity transfer rating of greater than or equal to approximately (⅛)C (e.g., approximately (¼)C, approximately (⅓)C, approximately (½)C, approximately 1C, approximately 2C, approximately 3C, etc.), where the electricity transfer rating refers to an electricity charge and/or discharge rating of the rechargeable energy storage system in terms of the electric current capacity of the rechargeable energy storage system in ampere-hours. Furthermore, the rechargeable energy storage system can also be configured with and/or can comprise an electric energy storage capacity of greater than or equal to approximately 1 kiloWatt-hour (kW-hr). For example, the rechargeable energy storage system can be configured with and/or can comprise an electric energy storage capacity of greater than or equal to approximately 20 kW-hrs and less than or equal to approximately 50 kW-hrs. In further examples, the rechargeable energy storage system can be configured with and/or can comprise an electric energy storage capacity of greater than or equal to approximately 5 kW-hrs and less than or equal to approximately 100 kW-hrs.

In specific examples, the rechargeable energy storage system can comprise (a) one or more batteries and/or one or more fuel cells, (b) one or more capacitive energy storage systems (e.g., super capacitors such as electric double-layer capacitors), and/or (c) one or more inertial energy storage systems (e.g., one or more flywheels). In many embodiments, the one or more batteries can comprise one or more rechargeable and/or non-rechargeable batteries. For example, the one or more batteries can comprise one or more lead-acid batteries, valve regulated lead acid (VRLA) batteries such as gel batteries and/or absorbed glass mat (AGM) batteries, nickel-cadmium (NiCd) batteries, nickel-zinc (NiZn) batteries, nickel metal hydride (NiMH) batteries, zebra (e.g., molten chloroaluminate (NaAlCl₄)) batteries, and/or lithium (e.g., lithium-ion (Li-ion)) batteries.

Meanwhile, the electric vehicle can comprise any full electric vehicle, any hybrid vehicle, and/or any other grid-connected vehicle. In the same or different embodiments, the electric vehicle can comprise any one of a car, a truck, motorcycle, a bicycle, a scooter, a boat, a train, an aircraft, an airport ground support equipment, and/or a material handling equipment (e.g., a fork-lift), etc. EVCS('s) 102 (e.g., multi-use EVCS('s) 108, public EVCS('s) 109, private EVCS('s) 110, multi-use EVCS 103, public EVCS 106, and/or private EVCS 107) can be affiliated with an electricity transfer system network (ETSN). The ETSN can refer to a network configured to facilitate the operation (e.g., in real time) of EVCS('s) 102 by supporting (e.g., remotely and/or centrally) EVCS('s) 102 with external resources (e.g., computer processing, data storage and/or aggregation, administration and/or billing, etc.) to provide additional functionality to EVCS('s) 102. The ETSN can be operated by an electricity transfer system network (ETSN) operator, which can use (a) ETSN computer system 101 and/or (b) an application programmable interface (API) (e.g., via cloud computing). As an example, the application programmable interface can communicate with ETSN computer system 101 (e.g., via communications module 111), one or more cloud computer systems, one or more private host computer systems, and/or one or more personal computer systems in order to administrate, operate, support, and/or control the ETSN, as described below. Accordingly, in these examples, some or all of the functionality of ETS 100 can be provided by ETSN computer system 101, the cloud computer system(s), the private host computer system(s), and/or the personal computer system(s). In a more detailed example, the application programmable interface can be operated (e.g., in the capacity of an interface only) at one or more processors and/or stored at one or more memory storage modules of ETSN computer system 101 while the remaining functional aspects of ETSN computer system 101, as described herein, are operable at one or more processors and/or storable at one or more memory storage modules of the cloud computer system(s), the private host computer system(s), and/or the personal computer system(s). For convenience of illustration, ETSN 100 is generally described with respect to ETSN computer system 101 only, but as indicated, each of the cloud computer system(s) described above with respect to the application programmable interface can be similar or identical to ETSN computer system 101, and can be implemented instead of and/or in addition to ETSN computer system 101 in order to administrate, operate, support, and/or control the ETSN. Further, any of the functionality described herein with respect to ETSN computer system 101 can be implemented by the application programmable interface and/or the cloud computer system(s).

In further embodiments, similar to the relationship of ETSN computer system 101 and the cloud computer system(s), the private host computer system(s) can be implemented alternatively (and/or additionally) as private host application programmable interface(s) (API('s)) and private host cloud computer system(s); and the personal computer system(s) can be implemented alternatively (and/or additionally) as personal application programmable interface(s) (API('s)) and personal cloud computer system(s). In these embodiments, the cloud computer system(s) of the ETSN application programmable interface can comprise the private host cloud computer system(s) and/or the personal cloud computer system(s), and/or vice versa. Further, the private host application programmable interface(s) can be operated and/or stored (e.g., self-contained) at the private host computer system(s); and/or the personal application programmable interface(s) can be operated and/or stored (e.g., self-contained) at the personal computer system(s). Moreover, the private host application programmable interface(s) and/or the private host cloud computer system(s) can provide some or all of the functionality (e.g., communication with ETSN computer system 101) of the private host computer system(s); and/or the personal application programmable interface(s) and/or the personal cloud computer system(s) can provide some or all of the functionality (e.g., communication with ETSN computer system 101) of the personal computer system(s).

In many embodiments, the ETSN operator can establish a structure dictating whether and to what extent users can use the ETSN. For example, users might be able (and/or required) to become members of the ETSN by, for example, paying an incremental (e.g., monthly, annually, etc.), one-off, and/or pay-per-use membership fee(s) to the ETSN operator in exchange for using EVCS('s) 102 and/or the ETSN. In some examples, membership (or one or more tiers of membership) can be free of membership fees. In further examples, users may still be allowed to use EVCS('s) 102 and/or the ETSN as guests without becoming members of the ETSN. Generally however, members of the ETSN can have more privileges and/or access to more services than guests of the ETSN. Meanwhile, in various embodiments, membership in an ETSN can be tiered such that some members (e.g., premium members) have more privileges and/or access to more services than other members (e.g., basic members). However, higher tiered memberships can cost more in membership fees than lower tiered memberships.

In many embodiments, members of the ETSN can be permitted by the ETSN operator to establish member accounts of the ETSN. Members can also be permitted to establish member profiles corresponding to their member accounts that permit those members (a) to manage their member accounts (e.g., provide member data, make payments for using the ETSN, ETS 100, and/or EVCS('s) 102, etc.), (b) to review electric vehicle data and/or rechargeable energy storage system data for their electric vehicles, (c) to reserve any of public EVCS('s) 109 and/or multi-use EVCS('s) 108, etc. Exemplary electric vehicle data can comprise maintenance requirements for the member's electric vehicle(s), locations of the member's electric vehicle(s) (e.g., provided by a global positioning system of the electric vehicle(s)), etc. Meanwhile, exemplary rechargeable energy storage system data can comprise a measured and/or calculated internal temperature of the rechargeable energy storage system of the member's electric vehicle, a measured and/or calculated internal pressure of the rechargeable energy storage system of the member's electric vehicle, a measured and/or calculated internal resistance free electric voltage of the rechargeable energy storage system of the member's electric vehicle, a state of charge of the rechargeable energy storage system of the member's electric vehicle, a state of health of the rechargeable energy storage system of the member's electric vehicle, a measured and/or calculated electric current at the rechargeable energy storage system of the member's electric vehicle, a measured and/or calculated electric voltage at the rechargeable energy storage system of the member's electric vehicle, etc.

Similarly, the ETSN operator can maintain operator profiles (e.g., via one or more computer databases stored at one or more memory storage modules of ETSN computer system 101) corresponding to the member accounts (a) that aggregate member data (e.g., personal information, financial and/or accounting information, etc.), electric vehicle data, and/or rechargeable energy storage system data relating to the members and (b) that make available the member data, the electric vehicle data, and/or the rechargeable energy storage system data to the members (e.g., via the member profiles) and to the ETSN operator. Further, the ETSN operator can also aggregate electric vehicle data and/or rechargeable energy storage system data relating to guests to make available that electric vehicle data and/or rechargeable energy storage system data to the ETSN operator, for research or various other purposes.

In many embodiments, members can access and/or manage their member profiles via a user interface of one of EVCS('s) 102 and/or remotely via their personal computing device (e.g., a desktop computer system, a laptop computer system, and/or any suitable mobile electronic computer system, such as, for example, a tablet computer system, and/or a smart phone, etc.).

Meanwhile, in various embodiments, the ETSN operator can also use the ETSN to provide advertising, public services announcements, government announcements, etc. to users of the ETSN (e.g., at EVCS('s) 102, at the member profiles, etc.) to obtain additional revenue. For example, the ETSN operator can stream advertising, public services announcements, government announcements, etc. to users of the ETSN and/or require that users of EVCS('s) 102 watch advertising, public services announcements, government announcements, etc. before being permitted to use EVCS('s) 102. In additional embodiments, the ETSN operator can also charge fees for reservation services via the ETSN.

In further embodiments, the ETSN operator can administrate charging and/or billing the user(s) of EVCS('s) 102 for use of EVCS('s) 102. For example, for a given transaction, the ETSN operator can charge and/or bill the user(s) of EVCS('s) 102 (a) based on a quantity (e.g., a net quantity) of electricity transferred, (b) based on access to the space approximately adjacent to a relevant EVCS of EVCS('s) 102, (c) based on the quantity of time the user(s) use (e.g., the time electricity is transferring) and/or occupy (e.g., the time plugged-in) the relevant EVCS of EVCS('s) 102, etc. Additionally, the ETSN operator can administrate charging and/or billing the user(s) of EVCS('s) 102 based on an aggregate quantity of time intervals for which the user(s) use and/or occupy the relevant EVCS of EVCS('s) 102.

As indicated previously, multi-use EVCS('s) 108, public EVCS('s) 109, and/or private EVCS('s) 110 can be distinguished from one another primarily in terms of accessibility and secondarily in terms of hardware implementation, as described below. The relevance of these distinctions is also explained below.

With respect to accessibility, private EVCS('s) 110 (e.g., private EVCS 107) can refer to one or more electric vehicle charging stations owned and/or leased (e.g., from the ETSN operator and/or a third-party leasor) by one or more private hosts. Meanwhile, public EVCS('s) 109 (e.g., public EVCS 106) can refer to electric vehicle charging stations owned and/or operated by the ETSN operator. Accordingly, the people who are able to use public EVCS('s) 109 can be established exclusively by the ETSN operator while the people who are able to use private EVCS('s) 110 can be established exclusively by the private host(s). Thus, users of ETSN 100 are free to use any available (e.g., unused and/or unreserved) public EVCS('s) 109, but can only use private EVCS('s) 110 upon receiving permission from the private hosts, whether that permission is provided by the hosts directly to the users or indirectly through an agreement with the ETSN operator. In some examples, a private host can refer to any host (or hosts) other than the ETSN operator (e.g., government and/or government entity host(s), commercial host(s) (e.g., a business, a group living establishment, such as, for example, an apartment complex, a group business establishment, such as, for example, a shopping mall, a private learning establishment, such as, for example, a private school and/or a private library, etc.), utility host(s), etc.). In further examples, a private host can also refer to a domestic host (e.g., one or more people having their electric vehicle charging station(s) at their personal residence such that the electric vehicle charging station(s) receive electricity from and/or provide electricity to the electric grid of the personal residence). Meanwhile, multi-use EVCS('s) 108 (e.g., multi-use EVCS 103) can be similar to private EVCS('s) 110 in that multi-use EVCS('s) 108 can be owned and/or leased by private hosts, but can also be configured to operate in a private mode and a public mode. When multi-use EVCS('s) 108 (e.g., multi-use EVCS 103) operate in the private mode, a private host establishes who is able to use its multi-use EVCS of multi-use EVCS('s) 108, but when multi-use EVCS('s) 108 (e.g., multi-use EVCS 103) operate in the public mode, the ETSN operator establishes who is able to use that particular multi-use EVCS. The dynamics of the private mode and public mode are described in further detail below.

With respect to hardware implementation, in some embodiments, multi-use EVCS('s) 108, public EVCS('s) 109, and/or private EVCS('s) 110 can all be implemented as multi-use EVCS('s) 108: (a) where public EVCS('s) 109 remain configured in the public mode and/or where the private mode is disabled and/or (b) where private EVCS('s) 110 remain configured in the private mode and/or where the public mode is disabled. Said another way, multi-use EVCS('s) 108, public EVCS('s) 109, and/or private EVCS('s) 110 can comprise the same hardware, but can be configured differently. Meanwhile, in other embodiments, multi-use EVCS('s) 108, public EVCS('s) 109, and/or private EVCS('s) 110 can comprise at least some hardware that is different from one another. Furthermore, in various embodiments, some of multi-use EVCS('s) 108, public EVCS('s) 109, and/or private EVCS('s) 110 can also be different from others of multi-use EVCS('s) 108, public EVCS('s) 109, and/or private EVCS('s) 110, respectively. For example, multi-use EVCS('s) 108 can effectively be implemented as an adapted version of private EVCS('s) 110 by comprising the same hardware as private EVCS('s) 110, plus additional hardware configured to permit multi-use EVCS('s) 108 to switch between the private mode and the public mode. Likewise, some private EVCS's of private EVCS('s) 110 can be different from other private EVCS's of private EVCS('s) 110. Specifically, some private EVCS's of private EVCS('s) 110 can comprise hardware configured to administrate authentication of users of the ETSN while other private EVCS's of private EVCS('s) 110 can lack such configuration. In many examples, multi-use EVCS('s) 108 (e.g., multi-use EVCS 103) can be similar to those private EVCS('s) of private EVCS('s) 110 that are configured to administrate authentication of users.

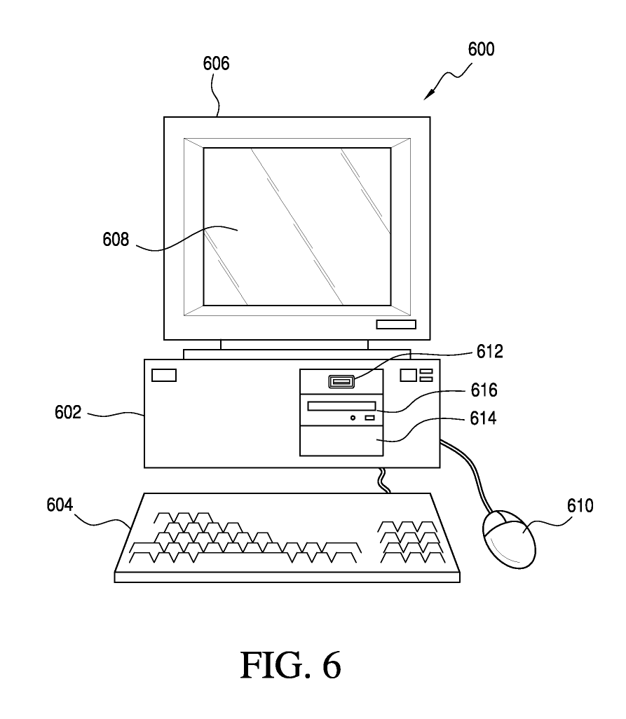

Each multi-use EVCS computer system 112 can be configured to administrate the functionality of one multi-use EVCS of multi-use EVCS('s) 108 (e.g., multi-use EVCS 103) as described above and below; each public EVCS computer system 113 can be configured to administrate the functionality of one public EVCS of public EVCS('s) 109 (e.g., public EVCS 106) as described above and below; and/or each private EVCS computer system 114 can be configured to administrate the functionality of one private EVCS of private EVCS('s) 110 (e.g., private EVCS 107) as described above and below. Multi-use EVCS computer system 112, public EVCS computer system 113, and/or private EVCS computer system 114 can be similar to each other and to computer system 600 (FIG. 6). Meanwhile, each multi-use EVCS computer system 112 can be similar or identical to each other; each public EVCS computer system 113 can be similar or identical to each other; and/or each private EVCS computer system 114 can be similar or identical to each other. Meanwhile, multi-use EVCS('s) 108, public EVCS('s) 109, and/or private EVCS('s) 110 can each comprise a user interface (e.g., a touch screen electronic display) to permit users to operate multi-use EVCS('s) 108, public EVCS('s) 109, and/or private EVCS('s) 110.

Having described the distinctions between multi-use EVCS('s) 108, public EVCS('s) 109, and/or private EVCS('s) 110, the following description explains the relevance of these distinctions, as indicated previously. First, the distinctions in hardware implementation serve to highlight the different aspects of implementing ETS 100. Specifically, while it may be desirable to standardize EVCS('s) 102 as much as possible, the ETSN may already be affiliated with and/or incorporate various ones of public EVCS('s) 109 and/or private EVCS('s) 110. Likewise, it may be desirable that some of EVCS('s) 102 are configured without the functionality of multi-use EVCS('s) 108, such as for cost or application purposes. In general, the description of the various hardware implementations is intended to indicate that ETS 100 can be implemented with an existing ETSN.

Meanwhile, the distinctions with respect to accessibility can be helpful to distinguish the advantages of multi-use EVCS('s) 108 when compared to public EVCS('s) 109, and/or private EVCS('s) 110. Specifically, while many private hosts may desire to make their multi-use EVCS('s) 108 and/or private EVCS('s) 110 available to others (e.g., users of the ETSN), at least some private hosts will not have such a desire. Indeed, private hosts such as, for example, government and/or government entity host(s), commercial host(s), utility host(s), etc. may desire for others (e.g., users of the ETSN) to use their multi-use EVCS('s) 108 and/or private EVCS('s) 110 in order to provide electric vehicle charging services to their employees, patrons, and/or customers. However, domestic hosts of the private hosts may not necessarily desire for others to use their multi-use EVCS('s) 108 and/or private EVCS('s) 110. Alternatively, domestic hosts of the private hosts may desire to permit others to use their multi-use EVCS('s) 108 and/or private EVCS('s) 110, but may not be able to do so without the operative support of the ETSN operator, the ETSN, and/or ETSN computer system 101. As a result, ETS 100 can make it possible for domestic hosts of the private hosts with multi-use EVCS('s) 108 to make available their multi-use EVCS('s) 108 for use by others (e.g., users of the ETSN). In some embodiments, the ETSN operator can also incentivize the private hosts to make their multi-use EVCS('s) 108 (e.g., multi-use EVCS 103) available for use to others (e.g., to operate their multi-use EVCS('s) 108 (e.g., multi-use EVCS 103) in the public mode), as described below.

Nonetheless, the distinctions with respect to accessibility are not intended to imply that users of multi-use EVCS('s) 108, public EVCS('s) 109, and/or private EVCS('s) 110 are necessarily treated differently with respect to the ETSN based on whether the user(s) are operating multi-use EVCS('s) 108, public EVCS('s) 109, and/or private EVCS('s) 110. Rather, the level of service provided by the ETSN can be determined by the guest and/or membership status of the user(s), as described above, and the accessibility distinctions are intended to illustrate the nature of use by the respective owner and/or lessee of multi-use EVCS('s) 108, public EVCS('s) 109, and/or private EVCS('s) 110.

ETS 100 can be advantageous for a number of reasons. First, when multi-use EVCS('s) 108 (e.g., multi-use EVCS 103) are operated in the public mode, multi-use EVCS('s) 108 (e.g., multi-use EVCS 103) can permit the ETSN operator to expand the scope of the ETSN. As a result, the users of the ETSN can use more of EVCS('s) 102, which provides the ETSN with more customers. Furthermore, the ETSN operator is able to provide advertising to more users via multi-use EVCS('s) 108 (e.g., multi-use EVCS 103) and to offer more options for reservation services. Meanwhile, depending on the incentive(s) offered by the ETSN operator to the private host(s) in exchange for operating the ETSN in the public mode, the private host(s) can recoup and/or offset their investments in (e.g., purchase of and/or lease of) multi-use EVCS('s) 108 (e.g., multi-use EVCS 103). Further still, because in many embodiments, only members of the ETSN can operate multi-use EVCS('s) 108 (e.g., multi-use EVCS 103) in the public mode, ETS 100 can also incentivize membership with the ETSN. Accordingly, the ETSN operator can obtain greater membership of the ETSN. Also, while ETS 100 can be implemented with respect to any private host, ETS 100 can be advantageously implemented with respect to the domestic host(s) of the private host(s) to expand hosting to neighborhoods and/or other areas where electric vehicle charging stations are not conventionally available for public use.

As mentioned above, the ETSN operator can offer incentive(s) to the private host(s) owning and/or leasing multi-use EVCS('s) 108 (e.g., multi-use EVCS 103) when operating multi-use EVCS('s) 108 (e.g., multi-use EVCS 103) in the public mode and/or when users of the ETSN use multi-use EVCS('s) 108 (e.g., multi-use EVCS 103) while multi-use EVCS('s) 108 (e.g., multi-use EVCS 103) are operating in the public mode. In some embodiments, the incentive(s) can comprise revenue sharing with the ETSN operator (and/or one or more other third parties). For example, the ETSN operator can share some (e.g., a percentage) or all revenues obtained from the user(s) of multi-use EVCS('s) 108 (e.g., multi-use EVCS 103) with the private host(s). Exemplary revenue can comprise revenue for use, for access, from advertising, and/or from reservation services, etc. In these or other embodiments, the incentive(s) can comprise electric vehicle charging station (EVCS) credits for the ETSN. For example, the ETSN operator can offer EVCS credits to the private host(s) as virtual currency permitting the private host(s) to pay for their own use of EVCS('s) 102. In some embodiments, the incentive(s) can simply offset energy costs of the private host(s) for operating multi-use EVCS('s) 108 (e.g., multi-use EVCS 103). However, in further embodiments, the incentive(s) can amount to a profit for the private host(s) and/or can pay for the investment(s) in multi-use EVCS('s) 108 (e.g., multi-use EVCS 103), as mentioned previously. Offering and/or providing EVCS credits to the private host(s) can be desirable where such EVCS credits are taxed differently than real currency. For example, the private host(s) may not have to pay taxes for the EVCS credits.

In some embodiments, the private host(s) can be permitted by the ETSN operator to establish the price for using multi-use EVCS('s) 108 (e.g., multi-use EVCS 103). In other embodiments, the cost rate of using some and/or all of EVCS('s) 102 (e.g., multi-use EVCS('s) 108) can be fixed by the ETSN operator, such as, for example, across the ETSN and/or by region. Fixing the cost rate of using some and/or all of EVCS('s) 102 (e.g., multi-use EVCS('s) 108) can refer to fixing the cost rate indefinitely and/or for a predetermined period of time, as desirable. Fixing the cost rate of using EVCS('s) 102 can permit standardization across the ETSN, allowing for ease of use and confidence of users of the ETSN. Because private commercial host(s) may want to establish a price below that of the fixed rate to encourage more customers to visit the commercial business, the ETSN operator can provide incentive(s) to private host(s) for permitting a fixed cost as well.

Meanwhile, the ETSN operator can also offer additional incentive(s) and/or the same incentive(s) to private host(s) for permitting additional functionality beyond access (e.g., advertisements, public service announcements, government messages, reservations, extended hours of operation, controllability of when the multi-use EVCS('s) 108 (e.g., multi-use EVCS 103) operate in the public mode, etc.). In some embodiments, the private host(s) can be permitted by the ETSN operator to establish whether the ETSN operator can provide (a) advertising, public services announcements, and/or government announcements, etc., and/or (b) reservation services at multi-use EVCS('s) 108 (e.g., multi-use EVCS 103). In some embodiments, the private host(s) can even be permitted to select (or prohibit) some or all of the advertisements, public service announcements, and/or government messages, etc. Likewise, in some embodiments, the private host can determine when multi-use EVCS('s) 108 (e.g., multi-use EVCS 103) operate in the private or public mode. In these latter embodiments, the ETSN operator can provide payment, one or more additional incentives, etc. in exchange for the ETSN taking over control of the public mode functionality of multi-use EVCS('s) 108 (e.g., multi-use EVCS 103).

In implementation, ETSN computer system 101 can be configured to communicate with EVCS('s) 102 (e.g., multi-use EVCS('s) 108, public EVCS('s) 109, private EVCS('s) 110, multi-use EVCS 103, public EVCS 106, and/or private EVCS 107). When multi-use EVCS('s) 108 are operating in the public mode, ETSN computer system 101 can administrate multi-use EVCS('s) 108 (e.g., multi-use EVCS 103) in a manner similar or identical to the manner in which ETSN computer system 101 administrates public EVCS('s) 109 and/or any private EVCS's of private EVCS('s) 110 that are made available to others, as described above. When multi-use EVCS('s) 108 are operating in the private mode, ETSN computer system 101 can administrate multi-use EVCS('s) 108 (e.g., multi-use EVCS 103) in a manner similar or identical to the manner in which ETSN computer system 101 administrates private EVCS's of private EVCS('s) 110 that are not made available to others, as described above. In many embodiments, ETSN computer system 101 can be similar or identical to computer system 600 (FIG. 6).

In some embodiments, EVCS('s) 102 (e.g., multi-use EVCS('s) 108, public EVCS('s) 109, private EVCS('s) 110, multi-use EVCS 103, public EVCS 106, and/or private EVCS 107) do not communicate with ETSN computer system 101. Instead, EVCS('s) 102 (e.g., multi-use EVCS('s) 108, public EVCS('s) 109, private EVCS('s) 110, multi-use EVCS 103, public EVCS 106, and/or private EVCS 107) can be configured to operate locally, such as, for example, according to local programming operating at the respective EVCS computer system(s) (e.g., multi-use EVCS computer system 112, public EVCS computer system 113, and/or private computer system 114) of EVCS('s) 102. For example, in these embodiments, one or more of multi-use EVCS('s) 108 can be locally programmed regarding when those multi-use EVCS('s) of multi-use EVCS('s) 108 operate in the public mode and when those multi-use EVCS('s) of multi-use EVCS('s) 108 operate in the private mode. Nonetheless, in these embodiments, EVCS('s) 102 (e.g., multi-use EVCS('s) 108, public EVCS('s) 109, private EVCS('s) 110, multi-use EVCS 103, public EVCS 106, and/or private EVCS 107) can be deprived of some or all of the support and/or functionality offered through communication with ETSN computer system 101.

Communication module 111 can be configured to permit communication between ETSN computer system 101, EVCS('s) 102 (e.g., multi-use EVCS('s) 108, public EVCS('s) 109, private EVCS('s) 110, multi-use EVCS 103, public EVCS 106, and/or private EVCS 107), at least one private host computer system (e.g., private host computer system 115) of the private host(s) of multi-use EVCS('s) 108, and/or at least one personal computer system of the user(s) of ETS 100 (FIG. 1). In general, in many embodiments, though not to be taken as limiting, some or all of the communications between the private host(s) and/or the user(s) with ETSN computer system 101 and/or the ETSN operator can occur via their respective private host computer system(s) and/or personal computer system(s), respectively. Exemplary private host computer system(s) can comprise desktop computer system(s), laptop computer system(s), and/or any suitable mobile electronic computer system(s), such as, for example, a tablet computer system(s), and/or a smart phone(s), etc. of the private host(s). Meanwhile, the personal computer system(s) can be similar to the host computer system(s) but with respect to the user(s) of ETS 100. Accordingly, in many embodiments, similar to ETSN computer system 101, each of the host computer system(s) and/or the personal computer system(s) can be similar or identical to computer system 600 (FIG. 6).

Communication module 111 can comprise a communication network comprising (a) one or more components configured to provide wired communication (e.g., one or more data buses, such as, for example, universal serial bus(es); one or more networking cables, such as, for example, coaxial cable(s), optical fiber cable(s), twisted pair cable(s); any other suitable data cable, etc.) and/or (b) one or more components configured to provide wireless communication (e.g., one or more radio transceivers, one or more infrared transceivers, etc.) between ETSN computer system 101, EVCS('s) 102 (e.g., multi-use EVCS('s) 108, public EVCS('s) 109, private EVCS('s) 110, multi-use EVCS 103, public EVCS 106, and/or private EVCS 107), the private host computer system(s), and/or the personal computer system(s). Communication module 111 can be configured to operate using any one or any multi-use of wired and/or wireless communication network topologies (e.g., ring, line, tree, bus, mesh, star, daisy chain, hybrid, etc.) and/or protocols (e.g., personal area network (PAN) protocol(s), local area network (LAN) protocol(s), wide area network (WAN) protocol(s), cellular network protocol(s), Powerline network protocol(s), etc.). Exemplary PAN protocol(s) can comprise Bluetooth, Zigbee, Wireless Universal Serial Bus (USB), Z-Wave, etc.; exemplary LAN and/or WAN protocol(s) can comprise Institute of Electrical and Electronic Engineers (IEEE) 802.3, IEEE 802.11, etc.; and exemplary wireless cellular network protocol(s) can comprise Global System for Mobile Communications (GSM), General Packet Radio Service (GPRS), Code Division Multiple Access (CDMA), Evolution-Data Optimized (EV-DO), Enhanced Data Rates for GSM Evolution (EDGE), 3GSM, Digital Enhanced Cordless Telecommunications (DECT), Digital AMPS (IS-136/Time Division Multiple Access (TDMA)), Integrated Digital Enhanced Network (iDEN), etc. The components forming the communication network of communication module 111 can be dependent on the network topologies and/or protocols in use, and vice versa.

Using communication module 111, ETSN computer system 101 can (a) command multi-use EVCS('s) 108 (e.g., multi-use EVCS 103) to operate in the public mode and/or the private mode and/or (b) receive notification that multi-use EVCS('s) 108 can be operated and/or are operating in the public mode and/or the private mode. For example, in some embodiments, the ETSN operator can dictate when multi-use EVCS('s) 108 (e.g., multi-use EVCS 103) operate in the public mode and/or the private mode. In further embodiments, the private host(s) of command multi-use EVCS('s) 108 (e.g., multi-use EVCS 103) can provide notification to ETSN computer system (e.g., via their host computer system(s) and/or host application programmable interface(s)) regarding when (e.g., now and/or at a predetermined time) multi-use EVCS('s) 108 (e.g., multi-use EVCS 103) can operate in the public mode and/or the private mode. Further, in many embodiments, the private host(s) can directly command multi-use EVCS('s) 108 (e.g., multi-use EVCS 103) to operate in the public mode and/or the private mode with their private host computer system(s) (e.g., now and/or at a predetermined time). In some of these embodiments, EVCS('s) 108 can notify ETSN computer system 101 that EVCS('s) 108 can be operated and/or are operating in the public mode and/or the private mode. In general, control of when multi-use EVCS('s) 108 (e.g., multi-use EVCS 103) operate in the public mode and/or the private mode can be implemented (a) directly and/or indirectly and/or (b) governed by the ETSN operator and/or the private host(s), and/or any desirable multi-use thereof.

Authentication module 104 can be configured to administrate authentication of any user(s) of EVCS('s) 102 (e.g., multi-use EVCS('s) 108, public EVCS('s) 109, private EVCS('s) 110, multi-use EVCS 103, public EVCS 106, and/or private EVCS 107) by identifying the user(s) and determining if the user(s) are permitted to use the ETSN and/or EVCS('s) 102 (e.g., multi-use EVCS('s) 108, public EVCS('s) 109, private EVCS('s) 110, multi-use EVCS 103, public EVCS 106, and/or private EVCS 107). Authentication can also serve the purpose of associating members of the ETSN with their respective member account, member profile, etc., and/or guests with their respective payment source.

Permission to use the ETSN and/or EVCS('s) 102 (e.g., multi-use EVCS('s) 108, public EVCS('s) 109, private EVCS('s) 110, multi-use EVCS 103, public EVCS 106, and/or private EVCS 107) for purposes of authentication can be established by the private host(s) and/or the ETSN operator, as described above. Accordingly, for private EVCS('s) 110 (e.g., private EVCS 107) permission can be limited to the private host(s) and/or a select group of people permitted to use their private EVCS('s) 110 (e.g., private EVCS 107). The ETSN operator, on the other hand, can expand permission to any of its customers, based on any suitable criteria. Exemplary criteria can comprise membership of the ETSN, solvency of the customer's bank account, credit card, and/or other payment source, etc. Accordingly, following the model of the public versus private mode described above and with respect to multi-use EVCS('s) 108 (e.g., multi-use EVCS 103), the ETSN operator can determine who is permitted to use multi-use EVCS('s) 108 (e.g., multi-use EVCS 103) when multi-use EVCS('s) 108 (e.g., multi-use EVCS 103) are operating in the public mode, and the private host(s) can determine who is permitted to use multi-use EVCS('s) 108 (e.g., multi-use EVCS 103) when multi-use EVCS('s) 108 (e.g., multi-use EVCS 103) are operating in the private mode.

Authentication can be disabled for some private EVCS('s) 110 (e.g., private EVCS 107) where use is limited to the private host(s) because the associated account for charging for the use is predetermined to be the private host(s). Authentication can take on increased importance though with respect to use of EVCS('s) 102 (e.g., multi-use EVCS('s) 108, public EVCS('s) 109, private EVCS('s) 110, multi-use EVCS 103, public EVCS 106, and/or private EVCS 107) because it permits the ETSN operator and/or the ETSN computer system 101 to distinguish users and to determine whom to bill for a given transaction. Thus, when operating multi-use EVCS('s) 108 (e.g., multi-use EVCS 103) in the public mode, authentication can be required in order to use multi-use EVCS('s) 108 (e.g., multi-use EVCS 103), such as, for example, to ensure the actual user, and not the private host, is billed for the transaction.

Authentication module 104 can be configured to administrate authentication of users by any suitable identification mechanism (e.g., radio frequency identification, magnetic strip identification, code identification, password identification, and/or near field communication identification, etc.). Meanwhile, authentication module 104 can be configured to operate cooperatively with communication module 111 in order to transmit authentication information between ETSN computer system 101 and EVCS('s) 102 (e.g., multi-use EVCS('s) 108, public EVCS('s) 109, private EVCS('s) 110, multi-use EVCS 103, public EVCS 106, and/or private EVCS 107), as applicable. Thus, authentication module 104 can comprise one or more identification mechanism(s) located at each of EVCS('s) 102 (e.g., multi-use EVCS('s) 108, public EVCS('s) 109, private EVCS('s) 110, multi-use EVCS 103, public EVCS 106, and/or private EVCS 107), as applicable, and one or more databases stored at one or more memory module of ETSN computer 101 against which to compare authentication information received at the relevant EVCS('s) 102 (e.g., multi-use EVCS('s) 108, public EVCS('s) 109, private EVCS('s) 110, multi-use EVCS 103, public EVCS 106, and/or private EVCS 107) and/or from personal computing device(s) of the user(s). Upon a successful match and/or association, authentication module 104 can instruct the relevant EVCS('s) 102 (e.g., multi-use EVCS('s) 108, public EVCS('s) 109, private EVCS('s) 110, multi-use EVCS 103, public EVCS 106, and/or private EVCS 107) to allow charging. As indicated above, some of EVCS('s) 102 (e.g., multi-use EVCS('s) 108, public EVCS('s) 109, private EVCS('s) 110, multi-use EVCS 103, public EVCS 106, and/or private EVCS 107) can omit any hardware for performing authentication, as applicable.

Another manner in which ETS 100 can be advantageous can be where a first private host's electric grid is unable to support as much electric power transfer as a second private host's electric grid. Such a scenario could be problematic if the first private host's electric vehicle and/or rechargeable energy storage system requires a higher power level electric charge than his electric grid supports. In these embodiments, the private hosts may desire to share one or more multi-use EVCS's of multi-use EVCS('s) 108 (e.g., multi-use EVCS 103) so that the first private host can draw electricity from the second private host's electric grid to effectively charge his electric vehicle and/or rechargeable energy storage system. By operating his multi-use EVCS of multi-use EVCS('s) 108 in the public mode, the second private host can simplify sharing the multi-use EVCS of multi-use EVCS('s) 108 by permitting the ETSN operator to handle the accounting of charges by the first private host instead of having to directly charge the second private host for the use.

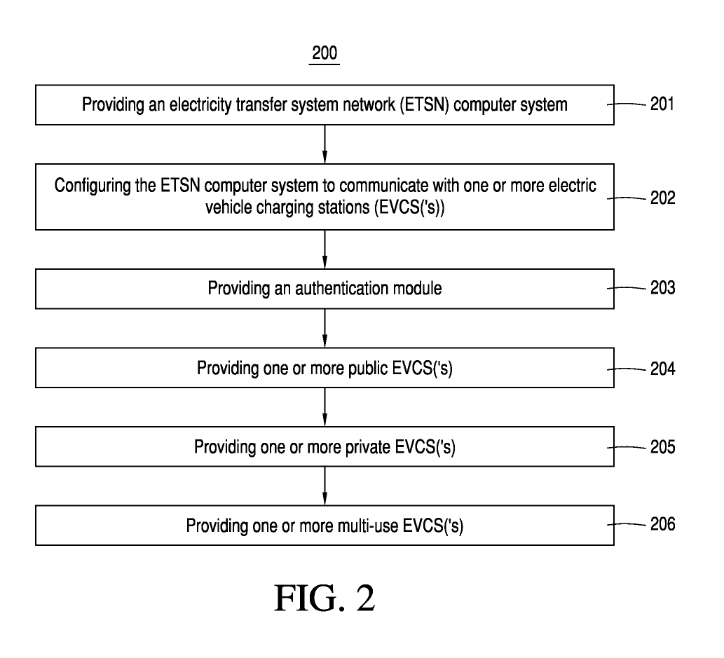

Turning to the next drawing, FIG. 2 illustrates a flow chart for an embodiment of method 200 of providing an electricity transfer system. Method 200 is merely exemplary and is not limited to the embodiments presented herein. Method 200 can be employed in many different embodiments or examples not specifically depicted or described herein. In some embodiments, the procedures, the processes, and/or the activities of method 200 can be performed in the order presented. In other embodiments, the procedures, the processes, and/or the activities of method 200 can be performed in any other suitable order. In still other embodiments, one or more of the procedures, the processes, and/or the activities in method 200 can be combined or skipped.

Method 200 can comprise procedure 201 of providing an electricity transfer system network (ETSN) computer system and/or an application programmable interface. The ETSN computer system can be similar or identical to ETSN computer system 101 (FIG. 1), and the application programmable interface can be similar or identical to the application programmable interface described above with respect to ETS 100 (FIG. 1). Accordingly, the application programmable interface can be configured to communicate with one or more cloud computer systems, each of which that can be similar or identical to the cloud computer system(s) described above with respect to ETS 100 (FIG. 1).

Method 200 can comprise procedure 202 of configuring the ETSN computer system and/or the application programmable interface to communicate with one or more electric vehicle charging stations (EVCS's). The EVCS('s) can be similar or identical to EVCS('s) 102. For example, the EVCS('s) can comprise one or more multi-use electric vehicle charging stations (EVCS's). The multi-use EVCS('s) can be similar or identical to multi-use EVCS('s) 108 (FIG. 1). Performing procedure 202 can comprise providing a communication module. The communication module can be similar or identical to communication module 111 (FIG. 1).

Method 200 can comprise procedure 203 of providing an authentication module. The authentication module can be similar or identical to authentication module 104 (FIG. 1). Performing procedure 203 can comprise configuring the authentication module to administrate the authentication of user(s) of one or more of the EVCS('s) (e.g., one or more of the multi-use EVCS('s)) by radio frequency identification, magnetic strip identification, code identification, password identification, and/or near field communication identification.

Method 200 can comprise procedure 204 of providing one or more public electric vehicle charging stations (EVCS's). The public EVCS('s) can be similar or identical to public EVCS('s) 109. In some embodiments, procedure 204 can be omitted.

Method 200 can comprise procedure 205 of providing one or more private electric vehicle charging stations (EVCS's). The private EVCS('s) can be similar or identical to private EVCS('s) 110. In some embodiments, procedure 205 can be omitted.

Method 200 can also comprise procedure 206 of providing the one or more multi-use EVCS('s).

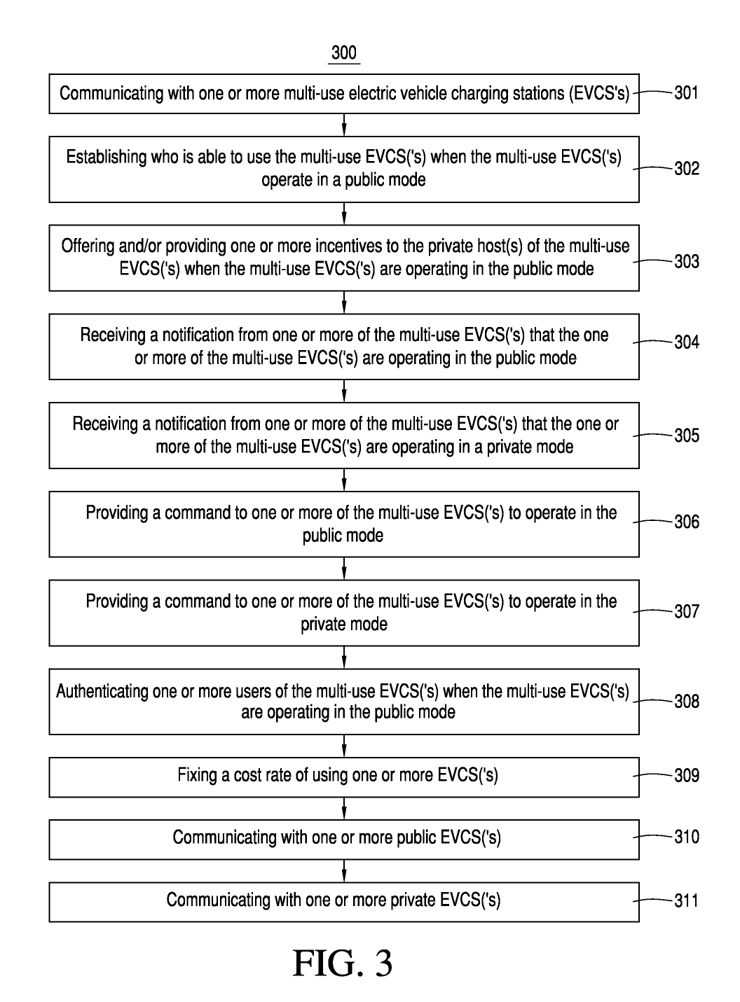

Turning to the next drawing, FIG. 3 illustrates a flow chart for an embodiment of method 300 of operating an electricity transfer system network (ETSN) computer system and/or an application programmable interface. In many embodiments, the application programmable interface can be configured to communicate with the ETSN computer system, one or more cloud computer systems, one or more private host computer systems, and/or one or more personal computer systems. Further, at least part of method 300 can be implemented via execution of computer instructions configured to run at one or more processing modules and configured to be stored at one or more memory storage modules of the ETSN computer system, the cloud computer system(s), the private host computer system(s), and/or the personal computer system(s). The ETSN computer system can be similar or identical to ETSN computer system 101 (FIG. 1) and/or computer system 600 (FIG. 6); the application programmable interface can be similar or identical to the application programmable interface described above with respect to ETS 100 (FIG. 1); the cloud computer system(s) can be similar or identical to the cloud computer system(s) described above with respect to ETS 100 (FIG. 1); the private host computer system(s) can be similar or identical to the private host computer system(s) described above with respect to ETS 100 (FIG. 1); and/or the personal computer system(s) can be similar or identical to the personal computer system(s) described above with respect to ETS 100 (FIG. 1). Method 300 is merely exemplary and is not limited to the embodiments presented herein. Method 300 can be employed in many different embodiments or examples not specifically depicted or described herein. In some embodiments, the procedures, the processes, and/or the activities of method 300 can be performed in the order presented. In other embodiments, the procedures, the processes, and/or the activities of method 300 can be performed in any other suitable order. In still other embodiments, one or more of the procedures, the processes, and/or the activities in method 300 can be combined or skipped.

Method 300 can comprise procedure 301 of communicating with one or more multi-use electric vehicle charging stations (EVCS's), such as, for example, via a communication module. The multi-use EVCS('s) can be similar or identical to multi-use EVCS('s) 108 (FIG. 1). Accordingly, the multi-use EVCS('s) can be owned and/or leased by one or more private hosts. The private host(s) can be similar or identical to the private host(s) described above with respect to ETS 100 (FIG. 1) Meanwhile, the communication module can be similar or identical to communication module 111 (FIG. 1). In many embodiments, procedure 301 can be repeated and/or performed independently for each of the multi-use EVCS('s).

Method 300 can comprise procedure 302 of establishing who is able to use the multi-use EVCS('s) when the multi-use EVCS('s) operate in a public mode. The public mode can be similar or identical to the public mode described above with respect to ETS 100 (FIG. 1). In many embodiments, procedure 302 can be repeated and/or performed independently for each of the multi-use EVCS('s).

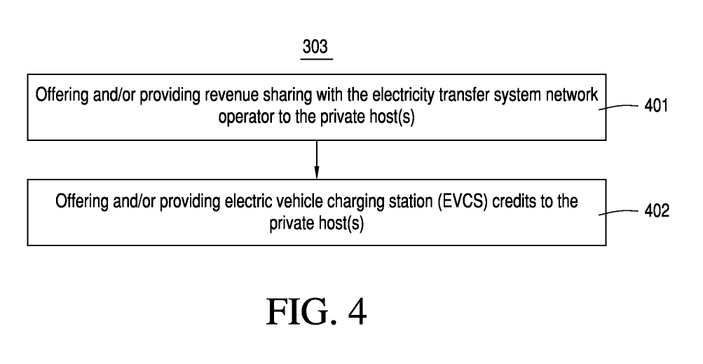

Method 300 can comprise procedure 303 of offering and/or providing one or more incentives to the private host(s) of the multi-use EVCS('s) when the multi-use EVCS('s) are operating in the public mode. The incentive(s) can be similar or identical to the incentive(s) described above with respect to the ETS 100 (FIG. 1). In many embodiments, procedure 303 can be repeated and/or performed independently for each of the multi-use EVCS('s) and/or private host(s). FIG. 4 illustrates an exemplary procedure 303.

Turning to FIG. 4, Procedure 303 can comprise process 401 of offering and/or providing revenue sharing with the electricity transfer system network operator to the private host(s). The revenue sharing can be similar or identical to the revenue sharing described above with respect to ETS 100 (FIG. 1). In many embodiments, process 401 can be repeated and/or performed independently for each of the private host(s). In some embodiments, process 401 can be omitted.

Procedure 303 can comprise process 402 of offering and/or providing electric vehicle charging station (EVCS) credits to the private host(s). The EVCS credits can be similar or identical to the EVCS credits described above with respect to ETS 100 (FIG. 1). In many embodiments, process 402 can be repeated and/or performed independently for each of the private host(s). In some embodiments, process 402 can be omitted.

Returning to FIG. 3, method 300 can comprise (a) procedure 304 of receiving a notification from one or more of the multi-use EVCS('s) that the one or more of the multi-use EVCS('s) are operating in the public mode, such as, for example, via the communication module, and/or (b) procedure 305 of receiving a notification from one or more of the multi-use EVCS('s) that the one or more of the multi-use EVCS('s) are operating in a private mode, such as, for example, via the communication module. The private mode can be similar or identical to the private mode described above with respect to ETS 100 (FIG. 1). In many embodiments, procedure 304 and/or procedure 305 can be repeated and/or performed independently for each of the multi-use EVCS('s). Performing procedure 304 can be similar or identical to receiving the notification from the one or more of the multi-use EVCS('s) that the one or more of the multi-use EVCS('s) are operating in the public mode as described above with respect to communications module 111 (FIG. 1) of ETS 100 (FIG. 1); and/or performing procedure 305 can be similar or identical to receiving the notification from the one or more of the multi-use EVCS('s) that the one or more of the multi-use EVCS('s) are operating in the private mode as described above with respect to communications module 111 (FIG. 1) of ETS 100 (FIG. 1).

Meanwhile, method 300 can also comprise (a) procedure 306 of providing a command to one or more of the multi-use EVCS('s) to operate in the public mode, such as, for example, via the communication module, and/or (b) procedure 307 of providing a command to one or more of the multi-use EVCS('s) to operate in the private mode, such as, for example, via the communication module. In some embodiments, procedure 306 and/or procedure 307 can be omitted. In many embodiments, procedure 306 and/or procedure 307 can be repeated and/or performed independently for each of the multi-use EVCS('s). Performing procedure 306 can be similar or identical to providing the command to one or more of the multi-use EVCS('s) to operate in the public mode as described above with respect to communications module 111 (FIG. 1) of ETS 100 (FIG. 1); and/or performing procedure 307 can be similar or identical to providing the command to one or more of the multi-use EVCS('s) to operate in the private mode as described above with respect to communications module 111 of ETS 100 (FIG. 1).

Method 300 can comprise procedure 308 of authenticating one or more users of the multi-use EVCS('s) when the multi-use EVCS('s) are operating in the public mode. In many embodiments, procedure 308 can be performed in a manner similar to authenticating one or more users of the multi-use EVCS('s) when the multi-use EVCS('s) are operating in the public mode as described above with respect to ETS 100 (FIG. 1). In many embodiments, procedure 308 can be repeated and/or performed independently for each of the multi-use EVCS('s).

In many embodiments, one or more of procedure 304 through procedure 308 can be performed as part of procedure 301.

In many embodiments, method 300 can comprise procedure 309 of fixing a cost rate of using one or more electric vehicle charging stations (EVCS's). The EVCS('s) can be similar or identical to EVCS('s) 102 (FIG. 1). Procedure 309 can also occur before any of procedures 302-308. In some embodiments, procedure 309 can be omitted. Performing procedure 309 can be similar or identical to fixing the cost rate of using the one or more electric vehicle charging stations (EVCS's) as described above with respect to ETS 100 (FIG. 1).

In some embodiments, method 300 can comprise procedure 310 of communicating with one or more public electric vehicle charging stations (EVCS's). The public EVCS('s) can be similar or identical to public EVCS('s) 109. In some embodiments, procedure 310 can be omitted. In many embodiments, procedure 310 can be repeated and/or performed independently for each of the public EVCS('s).

In further embodiments, method 300 can comprise procedure 311 of communicating with one or more private electric vehicle charging station (EVCS's). The private EVCS('s) can be similar or identical to private EVCS('s) 110. In some embodiments, procedure 311 can be omitted. In many embodiments, procedure 311 can be repeated and/or performed independently for each of the private EVCS('s).

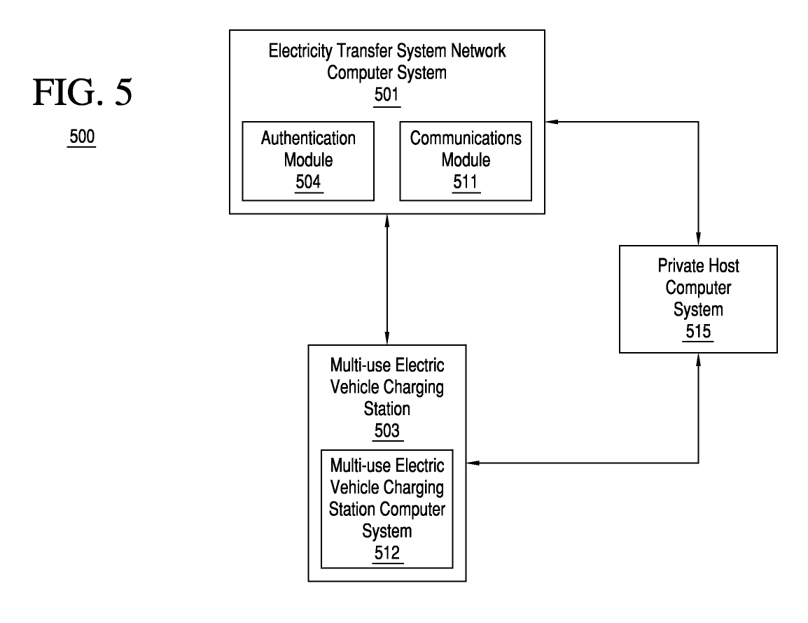

Turning to another drawing, FIG. 5 illustrates a representative block diagram of an electricity transfer system (ETS) 500, according to an embodiment. ETS 500 is merely exemplary and is not limited to the embodiments presented herein. ETS 500 can be employed in many different embodiments or examples not specifically depicted or described herein.

ETS 500 can comprise multi-use electric vehicle charging station (EVCS) 503 of a private host. Multi-use EVCS 503 can be configured to communicate with ETSN computer system 501 and/or an application programmable interface. The ETSN computer system can be similar or identical to ETSN computer system 101 (FIG. 1), and/or the application programmable interface can be similar or identical to the application programmable interface described above with respect to ETS 100 (FIG. 1). ETSN computer system 501 and/or the application programmable interface can be operated by an electricity transfer system network (ETSN) operator similar or identical to the ETSN operator described above with respect to ETS 100 (FIG. 1). ETS 500, ETSN computer system 501, and/or multi-use EVCS 503 can comprise authentication module 504 and communication module 511, which can be similar or identical to authentication module 104 (FIG. 1) and communication module 111 (FIG. 1), respectively. In many embodiments, multi-use EVCS 503 can comprise multi-use EVCS computer system 512, which can be similar or identical to multi-use EVCS computer system 112 (FIG. 1).

In some embodiments, multi-use EVCS 503 is not configured to communicate with ETSN computer system 501 and/or the application programmable interface. In these embodiments, multi-use EVCS 503 can be locally operated, such as, for example, by multi-use EVCS computer system 112 (FIG. 1).

In these embodiments, similar to multi-use EVCS 103 (FIG. 1), multi-use EVCS 503 can also be configured to operate in a private mode and a public mode. Accordingly, multi-use EVCS 503 can be similar or identical to multi-use EVCS 103 (FIG. 1) and/or any of multi-use EVCS('s) 108 (FIG. 1).

Also in these same embodiments, EVCS 503 and/or ETSN computer system 501 can be configured to communicate with private host computer system 515 or a host application programmable interface that is not coupled to ETSN computer system 501. Private host computer system 515 can be similar or identical to private host computer system 115 (FIG. 1).

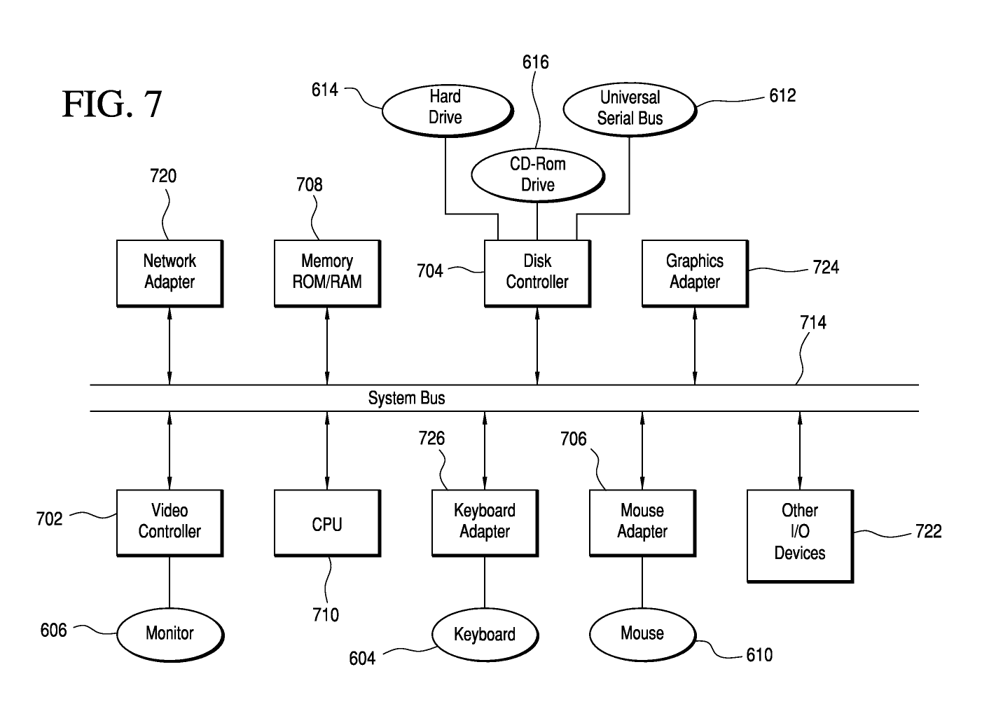

Turning again to the next drawing, FIG. 6 illustrates an exemplary embodiment of computer system 600, all of which or a portion of which can be suitable for implementing an embodiment of ETSN computer system 101 (FIG. 1), ETSN computer system 501 (FIG. 5), multi-use EVCS computer system 112 (FIG. 1), multi-use EVCS computer system 512 (FIG. 5), public EVCS computer system 113 (FIG. 1), private EVCS computer system 114 (FIG. 1) and/or any of various other elements of ETS 100 (FIG. 1) and/or ETS 500 (FIG. 5) as well as any of the various procedures, processes, and/or activities of method 300 (FIG. 3). As an example, a different or separate one of chassis 602 (and its internal components) can be suitable for implementing ETSN computer system 101 (FIG. 1), ETSN computer system 501 (FIG. 5), multi-use EVCS computer system 112 (FIG. 1), multi-use EVCS computer system 512 (FIG. 5), public EVCS computer system 113 (FIG. 1), private EVCS computer system 114 (FIG. 1), etc. Furthermore, one or more elements of computer system 600 (e.g., refreshing monitor 606, keyboard 604, and/or mouse 610, etc.) can also be appropriate for implementing ETSN computer system 101 (FIG. 1) and/or ETSN computer system 501 (FIG. 5). Computer system 600 comprises chassis 602 containing one or more circuit boards (not shown), Universal Serial Bus (USB) port 612, Compact Disc Read-Only Memory (CD-ROM) and/or Digital Video Disc (DVD) drive 616, and hard drive 614. A representative block diagram of the elements included on the circuit boards inside chassis 602 is shown in FIG. 7. Central processing unit (CPU) 710 in FIG. 7 is coupled to system bus 714 in FIG. 7. In various embodiments, the architecture of CPU 710 can be compliant with any of a variety of commercially distributed architecture families.

Continuing with FIG. 7, system bus 714 also is coupled to memory storage unit 708, where memory storage unit 708 comprises both read only memory (ROM) and random access memory (RAM). Non-volatile portions of memory storage unit 708 or the ROM can be encoded with a boot code sequence suitable for restoring computer system 600 (FIG. 6) to a functional state after a system reset. In addition, memory storage unit 708 can comprise microcode such as a Basic Input-Output System (BIOS). In some examples, the one or more memory storage units of the various embodiments disclosed herein can comprise memory storage unit 708, a USB-equipped electronic device, such as, an external memory storage unit (not shown) coupled to universal serial bus (USB) port 612 (FIGS. 6-7), hard drive 614 (FIGS. 6-7), and/or CD-ROM or DVD drive 616 (FIGS. 6-7). In the same or different examples, the one or more memory storage units of the various embodiments disclosed herein can comprise an operating system, which can be a software program that manages the hardware and software resources of a computer and/or a computer network. The operating system can perform basic tasks such as, for example, controlling and allocating memory, prioritizing the processing of instructions, controlling input and output devices, facilitating networking, and managing files. Some examples of common operating systems can comprise Microsoft® Windows® operating system (OS), Mac® OS, UNIX® OS, and Linux® OS.

As used herein, “processor” and/or “processing module” means any type of computational circuit, such as but not limited to a microprocessor, a microcontroller, a controller, a complex instruction set computing (CISC) microprocessor, a reduced instruction set computing (RISC) microprocessor, a very long instruction word (VLIW) microprocessor, a graphics processor, a digital signal processor, or any other type of processor or processing circuit capable of performing the desired functions. In some examples, the one or more processors of the various embodiments disclosed herein can comprise CPU 710.

In the depicted embodiment of FIG. 7, various I/O devices such as disk controller 704, graphics adapter 724, video controller 702, keyboard adapter 726, mouse adapter 706, network adapter 720, and other I/O devices 722 can be coupled to system bus 714. Keyboard adapter 726 and mouse adapter 706 are coupled to keyboard 604 (FIGS. 6-7) and mouse 610 (FIGS. 6-7), respectively, of computer system 600 (FIG. 6). While graphics adapter 724 and video controller 702 are indicated as distinct units in FIG. 7, video controller 702 can be integrated into graphics adapter 724, or vice versa in other embodiments. Video controller 702 is suitable for refreshing monitor 606 (FIGS. 6-7) to display images on a screen 608 (FIG. 6) of computer system 600 (FIG. 6). Disk controller 704 can control hard drive 614 (FIGS. 6-7), USB port 612 (FIGS. 6-7), and CD-ROM drive 616 (FIGS. 6-7). In other embodiments, distinct units can be used to control each of these devices separately.

In some embodiments, network adapter 720 can comprise and/or be implemented as a WNIC (wireless network interface controller) card (not shown) plugged or coupled to an expansion port (not shown) in computer system 600 (FIG. 6). In other embodiments, the WNIC card can be a wireless network card built into computer system 600 (FIG. 6). A wireless network adapter can be built into computer system 600 by having wireless communication capabilities integrated into the motherboard chipset (not shown), or implemented via one or more dedicated wireless communication chips (not shown), connected through a PCI (peripheral component interconnector) or a PCI express bus of computer system 600 (FIG. 6) or USB port 612 (FIG. 6). In other embodiments, network adapter 720 can comprise and/or be implemented as a wired network interface controller card (not shown). Accordingly, communications module 111 (FIG. 1) and/or communications module 511 (FIG. 5) can comprise a network adapter similar or identical to network adapter 720.

Although many other components of computer system 600 (FIG. 6) are not shown, such components and their interconnection are well known to those of ordinary skill in the art. Accordingly, further details concerning the construction and composition of computer system 600 and the circuit boards inside chassis 602 (FIG. 6) are not discussed herein.

When computer system 600 in FIG. 6 is running, program instructions stored on a USB-equipped electronic device connected to USB port 612, on a CD-ROM or DVD in CD-ROM and/or DVD drive 616, on hard drive 614, or in memory storage unit 708 (FIG. 7) are executed by CPU 710 (FIG. 7). A portion of the program instructions, stored on these devices, can be suitable for carrying out at least part of ETS 100 (FIG. 1) and/or ETS 500 (FIG. 5) as well as any of the various procedures, processes, and/or activities of method 300 (FIG. 3).

Although computer system 600 is illustrated as a desktop computer in FIG. 6, there can be examples where computer system 600 may take a different form factor while still having functional elements similar to those described for computer system 600. In some embodiments, computer system 600 may comprise a single computer, a single server, or a cluster or collection of computers or servers, or a cloud of computers or servers. Typically, a cluster or collection of servers can be used when the demand on computer system 600 exceeds the reasonable capability of a single server or computer. In many embodiments, ETSN computer system 101 (FIG. 1) and/or ETSN computer system 501 (FIG. 5) comprise a single server, or a cluster or collection of computers or servers, or a cloud of computers or servers.

Meanwhile, in some embodiments, multi-use EVCS computer system 112 (FIG. 1), multi-use EVCS computer system 512 (FIG. 5), public EVCS computer system 113 (FIG. 1), private EVCS computer system 114 (FIG. 1) may not have the level of sophistication and/or complexity of ETSN computer system 101 (FIG. 1) and/or ETSN computer system 501 (FIG. 5). For example, ETSN computer system 101 (FIG. 1), ETSN computer system 501 (FIG. 5), multi-use EVCS computer system 112 (FIG. 1), multi-use EVCS computer system 512 (FIG. 5), public EVCS computer system 113 (FIG. 1), and/or private EVCS computer system 114 (FIG. 1) can have only those processing capabilities and/or memory storage capabilities as are reasonably necessary to perform the functionality, described above with respect to ETS 100 (FIG. 1) and/or ETS 500 (FIG. 5), as applicable. In a more detailed example, multi-use EVCS computer system 112 (FIG. 1), multi-use EVCS computer system 512 (FIG. 5), public EVCS computer system 113 (FIG. 1), and/or private EVCS computer system 114 (FIG. 1) could be implemented as a microcontroller comprising flash memory, or the like. Reducing the sophistication and/or complexity of any of ETSN computer system 101 (FIG. 1), ETSN computer system 501 (FIG. 5), multi-use EVCS computer system 112 (FIG. 1), multi-use EVCS computer system 512 (FIG. 5), public EVCS computer system 113 (FIG. 1), and/or private EVCS computer system 114 (FIG. 1) can reduce the size and/or cost of implementing ETS 100 (FIG. 1) and/or ETS 500 (FIG. 5), as applicable. Nonetheless, in other embodiments, any of ETSN computer system 101 (FIG. 1), ETSN computer system 501 (FIG. 5), multi-use EVCS computer system 112 (FIG. 1), multi-use EVCS computer system 512 (FIG. 5), public EVCS computer system 113 (FIG. 1), and/or private EVCS computer system 114 (FIG. 1) may need additional sophistication and/or complexity to operate as desired.

Although the invention has been described with reference to specific embodiments, it will be understood by those skilled in the art that various changes may be made without departing from the spirit or scope of the invention. Accordingly, the disclosure of embodiments of the invention is intended to be illustrative of the scope of the invention and is not intended to be limiting. It is intended that the scope of the invention shall be limited only to the extent required by the appended claims. For example, to one of ordinary skill in the art, it will be readily apparent that procedures 201-206 of FIG. 2, procedure 301-311 of FIG. 3, and/or processes 401-402 of FIG. 4 may be comprised of many different procedures, processes, and activities and be performed by many different modules, in many different orders, that any element of FIGS. 1-7 may be modified, and that the foregoing discussion of certain of these embodiments does not necessarily represent a complete description of all possible embodiments.

All elements claimed in any particular claim are essential to the embodiment claimed in that particular claim. Consequently, replacement of one or more claimed elements constitutes reconstruction and not repair. Additionally, benefits, other advantages, and solutions to problems have been described with regard to specific embodiments. The benefits, advantages, solutions to problems, and any element or elements that may cause any benefit, advantage, or solution to occur or become more pronounced, however, are not to be construed as critical, required, or essential features or elements of any or all of the claims, unless such benefits, advantages, solutions, or elements are expressly stated in such claim.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

What is claimed is:

1) An electricity transfer system comprising:
at least one of an electricity transfer system network computer system or an application programmable interface configured to communicate with electric vehicle charging stations, the electric vehicle charging stations being affiliated with an electricity transfer system network and the at least one of the electric transfer system network computer system or the application programmable interface being configured to administrate the electricity transfer system network;
wherein:
the at least one of the electricity transfer system network computer system or the application programmable interface is operated by an electricity transfer system network operator;
the electric vehicle charging stations comprise a multi-use electric vehicle charging station of a private host;
the multi-use electric vehicle charging station is configured to operate in a private mode and a public mode;
when the multi-use electric vehicle charging station operates in the private mode, the private host establishes who is able to use the multi-use electric vehicle charging station;
when the multi-use electric vehicle charging station operates in the public mode, the electricity transfer system network operator establishes who is able to use the multi-use electric vehicle charging station; and
the electricity transfer system network operator offers one or more incentives to the private host when the multi-use electric vehicle charging station operates in the public mode.

2) The electricity transfer system of claim 1 wherein:
the electricity transfer system network operator determines when the multi-use electric vehicle charging station operates in the public mode.

3) The electricity transfer system of claim 1 wherein:
the one or more incentives comprise revenue sharing between at least the electricity transfer system network operator and the private host.

4) The electricity transfer system of claim 1 wherein:
the one or more incentives comprise electric vehicle charging station credits for the electricity transfer system network.

5) The electricity transfer system of claim 1 further comprising:
an authentication module;
wherein:
when the multi-use electric vehicle charging station is operating in the public mode, using the multi-use electric vehicle charging station to transfer electricity requires authentication of a user; and
the authentication module is configured to administrate the authentication of the user.

6) The electricity transfer system of claim 5 wherein:
the authentication module is configured to administrate the authentication of the user by at least one of radio frequency identification, magnetic strip identification, code identification, or near field communication identification.

7) The electricity transfer system of claim 1 wherein:
a cost rate of using each of the electric vehicle charging stations is fixed for the electric vehicle charging stations, including for the multi-use electric vehicle charging station when operating in the public mode.

8) The electricity transfer system of claim 1 wherein:
the electric vehicle charging stations comprise at least one of a public electric vehicle charging station of the electricity transfer system network or a private electric vehicle charging station of an other private host.

9) The electricity transfer system of claim 8 further comprising at least one of:
the multi-use electric vehicle charging station;
the public electric vehicle charging station; or
the private electric vehicle charging station.

10) The electricity transfer system of claim 1 wherein:
the one or more incentives permit the private host to recover at least part of a cost of one of purchasing or leasing the multi-use electric vehicle charging system.

11) The electricity transfer system of claim 1 wherein:
the private host is a domestic host.

12) The electricity transfer system of claim 1 wherein:
the private host determines when the multi-use electric vehicle charging station operates in the public mode;
the one or more incentives comprise electric vehicle charging station credits for the electricity transfer system network;
the electricity transfer system further comprises an authentication module;
when the multi-use electric vehicle charging station is operating in the public mode, using the multi-use electric vehicle charging station to transfer electricity requires authentication of a user;
the authentication module is configured to administrate the authentication of the user by at least one of radio frequency identification, magnetic strip identification, code identification, or near field communication identification; and
the electric vehicle charging stations comprise at least one of a public electric vehicle charging station of the electricity transfer system network or a private electric vehicle charging station of an other private host.

13) A method of providing an electricity transfer system, the method comprising:
providing at least one of an electricity transfer system network computer system or an application programmable interface; and
configuring the at least one of the electricity transfer system network computer system or the application programmable interface to communicate with electric vehicle charging stations, the electric vehicle charging stations being affiliated with an electricity transfer system network and the at least one of the electric transfer system network computer system or the application programmable interface being configured to administrate the electricity transfer system network;
wherein:
the at least one of the electricity transfer system network computer system or the application programmable interface is operated by an electricity transfer system network operator;
the electric vehicle charging stations comprise a multi-use electric vehicle charging station of a private host;
the multi-use electric vehicle charging station is configured to operate in a private mode and a public mode;
when the multi-use electric vehicle charging station operates in the private mode, the private host establishes who is able to use the multi-use electric vehicle charging station;
when the multi-use electric vehicle charging station operates in the public mode, the electricity transfer system network operator establishes who is able to use the multi-use electric vehicle charging station; and
the electricity transfer system network operator offers one or more incentives to the private host when the multi-use electric vehicle charging station operates in the public mode.

14) The method of claim 13 wherein:
the electricity transfer system network operator determines when the multi-use electric vehicle charging station operates in the public mode.

15) The method of claim 13 wherein:
the one or more incentives comprise revenue sharing between at least the electricity transfer system network operator and the private host.

16) The method of claim 13 wherein:
the one or more incentives comprise electric vehicle charging station credits for the electricity transfer system network.

17) The method of claim 13 further comprising:
providing an authentication module, wherein (a) when the multi-use electric vehicle charging station is operating in the public mode, using the multi-use electric vehicle charging station to transfer electricity requires authentication of a user, and (b) the authentication module is configured to administrate the authentication of the user.

18) The method of claim 17 further comprising:
configuring the authentication module to administrate the authentication of the user by at least one of radio frequency identification, magnetic strip identification, code identification, or near field communication identification.

19) The method of claim 13 wherein:
a cost rate of using each of the electric vehicle charging stations is fixed for the electric vehicle charging stations, including for the multi-use electric vehicle charging station when operating in the public mode.

20) The method of claim 13 wherein:
the electric vehicle charging stations comprise at least one of a public electric vehicle charging station of the electricity transfer system network or a private electric vehicle charging station of an other private host.

21) The method of claim 20 further comprising at least one of:
providing the multi-use electric vehicle charging station;
providing the public electric vehicle charging station; or
providing the private electric vehicle charging station.

22) A method of operating at least one of an electricity transfer system network computer system or an application programmable interface, at least part of the method being implemented via execution of computer instructions configured to run at one or more processing modules and configured to be stored at one or more memory storage modules of at least one of the electricity transfer system network computer system or one or more cloud computer systems, the method comprising:
executing one or more first computer instructions configured to communicate with a multi-use electric vehicle charging station of electric vehicle charging stations, the multi-use electric vehicle charging station being owned or leased by a private host and being configured to operate in a private mode and a public mode;
executing one or more second computer instructions configured to establish who is able to use the multi-use electric vehicle charging station when the multi-use electric vehicle charging station operates in the public mode; and
executing one or more third computer instructions configured to offer one or more incentives to the private host when the multi-use electric vehicle charging station operates in the public mode;
wherein:
the computer instructions comprises the first, second, and third computer instructions.

23) The method of claim 22 further comprising one of:
executing one or more fourth computer instructions configured to receive a notification from the multi-use electric vehicle charging station that the multi-use electric vehicle charging station is operating in the public mode; or
executing one or more fifth computer instructions configured to provide a command to the multi-use electric vehicle charging station to operate in the public mode.

24) The method of claim 22 wherein:
executing the one or more third computer instructions configured to offer the one or more incentives to the private host comprises executing one or more fourth computer instructions configured to offer revenue sharing between at least the electricity transfer system network operator and the private host.

25) The method of claim 22 wherein:
executing the one or more third computer instructions configured to offer the one or more incentives to the private host comprises executing one or more fourth computer instructions configured to offer electric vehicle charging station credits for the electricity transfer system network to the private host.

26) The method of claim 22 further comprising:
executing one or more fourth computer instructions configured to authenticate a user of the multi-use electric vehicle charging station when the multi-use electric vehicle charging station is operating in the public mode.

27) The method of claim 22 further comprising:
fixing a cost rate of using each of the electric vehicle charging stations, including the multi-use electric vehicle charging station when operating in the public mode.

28) The method of claim 22 further comprising at least one of:
executing one or more fourth computer instructions configured to communicate with a public electric vehicle charging station of the electric vehicle charging stations; or
executing one or more fifth computer instructions configured to communicate with a private electric vehicle charging station of the electric vehicle charging stations.

29) An electricity transfer system comprising:
a multi-use electric vehicle charging station of a private host, the multi-use electric vehicle charging station being configured (a) to communicate with at least one of an electricity transfer system network computer system or an application programmable interface and (b) to operate in a private mode and a public mode;
wherein:
the at least one of the electricity transfer system network computer system or the application programmable interface is configured to communicate with electric vehicle charging stations, the electric vehicle charging stations being affiliated with an electricity transfer system network, and the electric transfer system network computer system being configured to administrate the electricity transfer system network;
the at least one of the electricity transfer system network computer system or the application programmable interface is operated by an electricity transfer system network operator;
the electric vehicle charging stations comprise the multi-use electric vehicle charging station;
when the multi-use electric vehicle charging station operates in the private mode, the private host establishes who is able to use the multi-use electric vehicle charging station;
when the multi-use electric vehicle charging station operates in the public mode, the electricity transfer system network operator establishes who is able to use the multi-use electric vehicle charging station; and
the electricity transfer system network operator offers one or more incentives to the private host when the multi-use electric vehicle charging station operates in the public mode.

30) The electricity transfer system of claim 29 wherein:
the one or more incentives comprise revenue sharing between at least the electricity transfer system network operator and the private host.

31) The electricity transfer system of claim 29 wherein:
the one or more incentives comprise electric vehicle charging station credits for the electricity transfer system network.

32) The electricity transfer system of claim 29 wherein:
the private host is a domestic host.

33) An electricity transfer system comprising:
a multi-use electric vehicle charging station of a private host, the multi-use electric vehicle charging station being configured to operate in a private mode and a public mode;
wherein:
when the multi-use electric vehicle charging station operates in the private mode, the private host establishes who is able to use the multi-use electric vehicle charging station;
when the multi-use electric vehicle charging station operates in the public mode, an electricity transfer system network operator establishes who is able to use the multi-use electric vehicle charging station; and
the electricity transfer system network operator offers one or more incentives to the private host when the multi-use electric vehicle charging station operates in the public mode.
